(19) United States
(12) Patent Application Publication
(10) Pub. No.: US 2008/0227651 A1
(43) Pub. Date: Sep. 18, 2008

(54) Cyclic voltammetry (CV) for identifying genomic sequence variations and detecting mismatch base pairs, such as single nucleotide polymorphisms

(76) Inventors: Yanxiu Zhou, West Hartford, CT (US); Bin Yu, West Hardford, CT (US); Kalle Levon, Brooklyn, NY (US)

Correspondence Address: STRAUB & POKOTYLO, 788 Shrewsbury Avenue, TINTON FALLS, NJ, 07724, US

(21) Appl. No.: 11/089,436

(22) Filed: Mar. 24, 2005

Related U.S. Application Data
(60) Provisional application No. 60/556,234, filed on Mar. 25, 2004.

(51) Int. Cl. C40B 30/00; C40B 40/06; C40B 50/18

(52) U.S. Cl. 506/7; 506/16; 506/32

(57) ABSTRACT

Cyclic voltammetry (CV) may be used with novel sensors for identifying the presence of target sequences complementary to probe sequences. The sensor may include an electrode layer (which is used as a working electrode in a CV system), a conductive polymer layer, and probes immobilized (e.g., via sulfur) on the conductive polymer layer. The conductive polymer layer may be polyaniline, or the like. The probes may be immobilized on the polymer layer using an electro-chemical immobilization technique in the presence of nucleophiles, such as thiol groups for example. The probes may be oligionucleotides. Thus, the sensors may be used for identifying genomic sequence variations and detecting mismatch base pairs, such as single nucleotide polymorphisms (SNPs) for example.

### § 0.1 CROSS REFERENCE TO RELATED APPLICATIONS

This application claims the benefit of U.S. Provisional Patent Application Ser. No. 60/556,234 (incorporated herein by reference), titled “CYCLIC VOLTAMETRY (CV) FOR IDENTIFYING GENOMIC SEQUENCE VARIATIONS AND DETECTING MISMATCH BASE PAIRS, SUCH AS SINGLE NUCLEOTIDE POLYMORPHISMS,” filed on Mar. 25, 2005.

### § 0.2 GOVERNMENT FUNDING

This invention was made with Government support and the Government has certain rights in the invention as provided for by contract number 0660076225 awarded by DARPA.

### §1. BACKGROUND

§ 1.1 Field of the Invention

This invention relates generally to the field of sensors and in particular to biosensors specific to nucleotide sequences.

The Human Genome Project, with its successful genetic analysis, was based on technological advances in the collection of genetic information. Furthering genetics research, techniques for identifying genomic sequence variations and detecting mismatch base pairs, such as single nucleotide polymorphisms (SNPs), are considered to be important for the future treatment of genetic disease. DNA chips are a major component needed for collecting data effectively.

The operation of DNA chips is based on differential hybridization, since the binding energy of a mutated test sequence to a single stranded probe is lower than the binding energy of completely complimentary strand. Thus, a mutation may be identified by its diminished association to a probe in the array.

§1.3 Related Art

A DNA microarray is typically a piece of glass or plastic on which different molecules of DNA have been affixed at different predetermined locations thereby forming a microscopic array. Scientists use DNA microarrays to screen a biological sample for presence of many genetic sequences at once. The affixed DNA segments are commonly referred to as “probes.” Often, thousands of different probe types are used in a single DNA microarray making it an effective research tool.
§ 1.3.1 Types of Microarrays

Microarrays from Affymetrix of Santa Clara, Calif. use short oligonucleotide (“ODNs”) probes of 25 bases or less. Other microarrays use polymerase chain reaction (“PCR”) products, genomic DNAs, bacterial artificial chromosomes (“BACs”), plasmids, or longer oligos (35 to 70 bases).
§ 1.3.2 Known Ways to Fabricate Microarrays

Microarrays may be made by any number of technologies including printing with fine-pointed pins onto glass slides, photolithography using pre-made masks, photolithography using dynamic micro mirror devices, or ink-jet printers. Genetic diagnostics use oligonucleotides (ODN) as the probes linked to solid supports by various different covalent immobilization methods to obtain a matrix bearing numerous ODN's immobilized at spatially defined positions on a small area. This allows sequencing by hybridization. In situ synthesis of ODN on microslides using synthetic mask (See, e.g., Maskos, U., and Southern, E., (1992) Nucleic Acids Res., 20, 1675-1678. and Maskos, U., and Southern, E., (1992) Nucleic Acids Res., 21, 4663-4669.), microrobotic spotting of modified microdroplets on an activated support (See, e.g., Khrapko, K. R., Lysov, Y. P., Khorlin, A. A., Shick, V. V., Florentiev, V. I., and Mirzabekov, A. D., (1989) Febs Letters, 256, 118-122; and Khrapko, K. R., Lysov, Y. P., Khorlin, A. A., Ivanov, I. B, Yershov, G. M., Vasilenko, S. K., Florentiev, V. I., and Mirzabekov, A. D., (1991) J. DNA Seq., 1, 375-388; and Bettie, K., Eggers, M., Shumaker, J., Hogan, M., Varma, R., Lanture, J., Hollis, M., Ehrlich, D., and Rathman, D., (1993) Clin. Chem., 39, 719-722.) and local support for the photodeprotection with the coupling of a nucleotide from in situ synthesis of ODN have all resulted in commercial development in genetic diagnostics.
§ 1.3.3 How Microarrays Work

Typically, microarrays are used to detect the presence of mRNAs that may have been transcribed from different genes and which encode different proteins. The RNA is extracted from many cells, ideally from a single cell type, and then converted to cDNA or cRNA. The copies may be “amplified” in concentration by rtPCR.

Fluorescent tags may be incorporated into the newly synthesized strands enzymatically, or may be attached to the new strands of DNA or RNA chemically.

A cDNA or cRNA molecule that contains a sequence complementary to one of the single-stranded probe sequences will hybridize (or “stick”), via base pairing (more at DNA), to the spot at which the complementary probes are affixed. The spot will then fluoresce (or glow) when examined using a microarray scanner, which typically includes a laser light source. Increased or decreased fluorescence intensity indicates that cells in the sample have recently transcribed, or ceased transcription of, a gene that contains the probed sequence. The intensity of the fluorescence corresponds to the number of copies of a particular mRNA that were present and thus indicates the activity or expression level of that gene. Thus, arrays can be used to profile which genes in the genome are active in a particular cell type and under a particular condition.
§ 1.3.4 Uses of Microarrays

Because many proteins have unknown functions, and because many genes are active all the time in all kinds of cells, researchers usually use microarrays to make comparisons between similar cell types. For example, an RNA sample from tumor cells might be compared to a sample from healthy cells. Probes that bind RNA in the tumor sample but not in the healthy one may indicate genes that are uniquely associated with the disease. Typically in such a test, the two samples' cDNAs are tagged with two distinct colors, enabling comparison on a single chip.

Since there are hundreds or thousands of distinct probes on a microarray, each microarray experiment can accomplish the equivalent of thousands of genetic tests in parallel. Microarrays have therefore dramatically accelerated many types of investigations.

Microarrays are also being used to identify genetic mutations and variation in individuals and across populations. Short oligonucleotide arrays can be used to identify the single nucleotide polymorphisms (“SNPs”) that are thought to be responsible for genetic variation and the source of susceptibility to genetically caused diseases. That is, an SNP is a DNA sequence variation, occurring when a single nucleotide—adenine (A), thymine (T), cytosine (C) or guanine (G)—in the genome is altered. Variations in the DNA sequences of humans can affect how humans handle diseases, bacteria, viruses, chemicals, drugs, etc. Accordingly, SNPs are of great value to biomedical research and developing pharmacy products.
§ 1.3.5 Perceived Problems with Know Microarrays and Nucleotide Related Sensors That use Flourescence-Based Detection

The foregoing microarrays rely on measuring changes in fluorescence intensity of the label attached to the probe during the specific binding process. This is disadvantageous because labeling is required, quality depends on labeling density, and optical readout and interpretation of fluorescent labels may require sophisticated and expensive equipment.
§ 1.3.6 Detecting Genetic Variations Without Flourescence

Several approaches for detecting genetic variations using electrically conducting materials have been initiated. The first such approach was to use electrochemical polymerization of pyrrole to investigate the homogeneity of the polymer film for the ODN probe distribution. However, the hybridization itself was measured with non-conducting methods—namely fluorescent labels. (See, e.g., Livache, T., Roget, A., Dejean, E., Barthet, C., Bidan, G., and Teoule, R., Nucleic Acids Res., (1994) 22, 2915-2921; and Livache, T., Fouque, B., Roget, A., Marchand, J., Bidan, G., Teoule, R.; and Mathis, G., (1998) Analytical Biochemistry, 255, 188-194.) Specifically, electro-copolymerization of pyrrole and pyrrole-ODN (ODN covalently linked to pyrrole monomer with a spacer) was performed. A classical electrochemical cell including two 1 cm² platinum electrodes (working and counter electrodes) and a salt saturated calomel electrode as reference (SCE) was used. Polymerization was performed by potential sweeping, and the oxidation started at 0.6 V. The ODN was linked to 1-N-aminoethylpyrrole. 25% of pyrrole-ODN was incorporated by physical entrapment, but subsequent hybridizations could not be done: the complementary ODN could not “find” the entrapped part of ODN. Copolymer composition was 1 pyrrole-ODN for 60,000 pyrrole units in the film. The hybridization of complementary ODN’ was done by using ³²P labeled ODN.

The same group worked on Polypyrrole DNA chip on a Silicon Device. An ODN array consisting of a matrix of microelectrodes, each one of which was covered by polypyrrole grafted on an ODN, was discussed. The array was prepared by successive electrochemical co-polymerizations. Saturation of the Ppy surface occurred when the ratio of Py vs Py-ODN was 30,000. (The density of ODN was 200 fmol/mm² (=120,000 molecules/μm².) The detection was carried out by fluorescence microscopy through an R-phycoerythrin label.

Later, efforts for DNA attachment with conducting polymers have included interpolymer complexation between the macromolecules (See, e.g., Sergeyev, V. G., Lokshin, N. A., Golubev, V. B., Zezin A. B., Levon, K., Kabanov V. A. Doklady Physical Chemistry, 2003, 390, 66.), enzymatic template polymerization of aniline (See, e.g., Liu, W., Kumar, J., Tripathy, S., Senecal, K. J., Samuelson, L., J. Am. Chem .Soc. 1999, 121, 71; Nagarajan, R., Tripathy, S., Kumar, J., Bruno, F. F., Samuelson, L., “An enzymatically synthesized conducting polymer complex of polyaniline and poly(vinylphosphonic acid)” Macromolecules, 2000, 33, 9542; and Nagarajan, R., Liu, W., Kumar, J., Tripathy, S., Bruno, F. F., Samuelson, L. A., “Manipulating DNA conformation using intertwined conducting polymer chains” Macromolecules, 2001, 34, 3921.) and electrochemical polymerization of the functionalized monomer (See, e.g., Francis Gamier, Hafsa Korri-Youssoufi, Pratima Srivastava, Bernard Mandrand, Thierry Delair, Toward intelligent polymers: DNA sensors based on oligonucleotide-functionalized polypyrroles.] Synthetic Metals 100 (1000) 89-94.).

The cyclic voltammogram of ODN-functionalized polypyrrole was not modified in the presence of non-complimentary ODN in the solution, while a significant modification of the voltammogram was observed upon addition of the complimentary ODN target—not a strong decrease of the reduction or oxidation peak maximum values, but the shape of the curve was affected.

An additional redox active label within a sandwich structure has been needed for desired resolution. (See, e.g., Anthony Guiseppi-Elie, IX^{th} International Seminar on the Technology of Inherently Conductive Polymers, Monterey, California, USA. Jun. 17-19, 2002; and Sean Brahim, Dyer Narinesingh and Anthony Guiseppi-Elie, “Bio-smart Hydrogels: Co-joined Molecular Recognition and Signal Transduction in Biosensor Fabrication and Drug Delivery,” Biosensors and Bioelectronics, 2002, 17(11-12): 973-981.) Thus, unfortunately, these techniques also require a label—they simply use redox active labels rather than florescent labels. Accordingly, these techniques have similar disadvantages in that they require labeling.
§ 1.3.7 Useful and Desirable Attributes of Sensors for Detecting Genetic Variations

In view of the foregoing, it would be useful and desirable to have means and techniques for detecting genetic variations, such as by using DNA specific hybridization reactions without the need for “reporter molecules” such as fluorescent labels and redox active labels. It would be useful and desirable for such means and techniques to be highly selective for complementary and mismatched target sequences. For example, it would be useful and desirable to be able to detect SNPs. It would be useful and desirable for such detections to be relatively quick (e.g., 5 to 10 minutes). It would be useful and desirable if such sensors where easy to fabricate. It would be useful and desirable if such means and techniques do not need any additional labeling to detect the hybridization process. Finally, it would be useful and desirable for such means and techniques were inexpensive (e.g., avoiding elaborate, expensive equipment), yet accurate.

### § 2. SUMMARY OF THE INVENTION

Methods, apparatus and compositions of matter consistent with the present invention use, or may be used with, cyclic voltammetry (CV) for identifying genomic sequence variations and detecting mismatch base pairs, such as single nucleotide polymorphisms (SNPs) for example.

A sensor consistent with the present invention may include (a) a conducting or semi-conducting polymer, and (b) probes immobilized, via sulfur, on the polymer, wherein the probes are selected from a group consisting of (A) oligonucleotides, (B) polymerase chain reaction products, (C) genomic DNAs, (D) bacterial artificial chromosomes, and (E) plasmids. In at least one embodiment consistent with the present invention, the polymer acts as an electrode. In at least one other embodiment consistent with the present invention, the sensor includes an electrode layer, wherein the polymer is provided on the electrode layer. In at least one embodiment consistent with the present invention, the polymer layer includes polyaniline. In at least one embodiment consisitent with the present invention, the polymer has a leucoemeraldine state backbone.

A method for fabricating a sensor consistent with the present invention may include (a) providing the polymer layer, and (b) immobilizing the probes on the polymer layer using an electro-chemical immobilization technique in the presence of nucleophiles, such as thiol groups for example.

A method for using a sensor consistent with the present invention may include (a) providing, in a cell including the sample solution, the sensor, (b) providing an auxiliary electrode in the cell including the sample solution, (c) applying a cyclic voltage to the auxiliary electrode, (d) measuring a current from the polymer layer, and (e) determining whether or not the sample solution includes the target entities using a value of the current.

### § 3. BRIEF DESCRIPTION OF THE DRAWINGS

FIG. 1 is a diagram illustrating a sensor consistent with the present invention.

FIG. 2 illustrates the attachment of an ODN probe to a polyaniline film surface.

FIG. 3 illustrates a CV test cell consistent with the present invention.

FIG. 4 illustrates a CV test system consistent with the present invention.

FIG. 5 is a flow diagram of an exemplary method for detecting a target in solution, in a manner consistent with the present invention.

FIGS. 6A-6C illustrate cyclic voltammograms illustrating the influence of buffer fluid on CV test measurements of an experimental sensor consistent with the present invention.

FIGS. 7A and 7B illustrate cyclic voltammograms of a (partial) sensor with polyaniline film and a sensor with ODN immobilized on polyaniline film.

FIG. 8 illustrates the influence of blocking time on peak current using experimental sensors consistent with the present invention.

FIG. 9 illustrates the influence of ODN density on peak current using experimental sensors consistent with the present invention.

FIG. 10 illustrates the influence of buffer on current differences when an experimental sensor, consistent with the present invention, is exposed to complementary DNA and non-complementary DNA.

FIG. 11 illustrates the influence of hybridization temperature on cyclic voltammograms using an experimental sensor consistent with the present invention.

FIG. 12 illustrates the influence of hybridization time on peak current using experimental sensors consistent with the present invention.

FIGS. 13A and 13B illustrate the influence of washing and washing times on peak current using an experimental sensor consistent with the present invention.

FIGS. 14A and 14B illustrate the influence of target concentration during incubation on peak current using experimental sensors consistent with the present invention.

FIGS. 15A and 15B illustrate the influence of target concentration during incubation peak current using an experimental sensor consistent with the present invention.

FIGS. 16A and 16B illustrate the influence of target concentration during incubation on peak current using an experimental sensor consistent with the present invention.

FIGS. 17A and 17B illustrate the influence of target concentration during incubation on peak current using an experimental sensor consistent with the present invention.

### § 4. DETAILED DESCRIPTION

The following description is presented to enable one skilled in the art to make and use our invention, and is provided in the context of further particular embodiments and methods. The present invention is not limited to the particular embodiments and methods described.

§ 4.1 Definitions

“ODN” means oligonucleotide.

An “SNP” is a nucleotide (e.g., DNA) sequence variation, occurring when a single nucleotide: adenine (A), thymine (T), cytosine (C) or guanine (G)—in the sequence is altered.

The prefix “c” means complementary. Thus, for example, cDNA means complementary DNA.

The prefix “nc” means non-complementary.

“Conductive” and “conducting” materials are intended to include “semi-conductive” materials.

§ 4.2 Exemplary Sensors

The following sensors exploit the fact that given nucleotide strands immobilized on an conductive (or semi-conductive) substrate will have a binding energy with a complementary strand that is greater than the binding energy of a non-complementary strand (e.g., a mutated strand, an SNP, etc.).

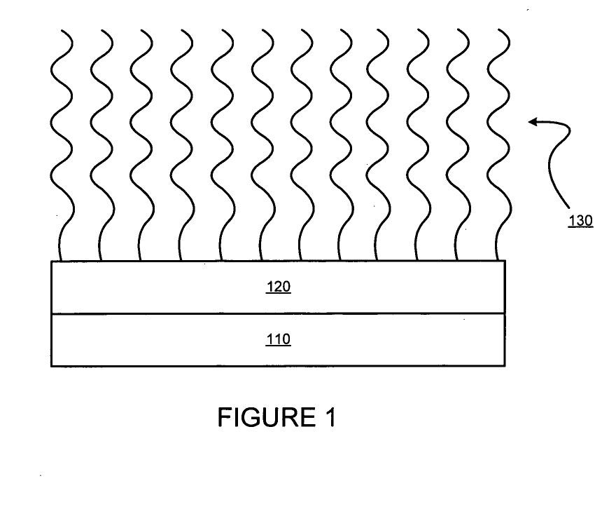

FIG. 1 is a diagram of an exemplary sensor. Although this diagram is provided as a two-dimensional cross section, it should be understood that the elements are three-dimensional. The sensor includes an electrode substrate 110, a conductive immobilization layer 120, and probes 130 immobilized onto the layer 120.

In one embodiment, the electrode 110 is ITO glass, the conductive immobilization layer 120 is a three dimensional network of polyaniline and the probes 130 are ODNs. Specific ODNs discussed in detail below include
5′-CCT/AAG/AGG/GAG//TG-3′,5′-TCA/ATC/TCG/GGA/ATC/TCA/ATG/TTA/G-3,
5′-TGT/GAC/AAC/CAC/ATC/ACT/GT-3′, and
5′-TGT/GAC/AAC/CAC/ATC/ACT/GA-3′.

Alternative electrodes 110 include, for example, platinum, glassy carbon, etc. In at least one embodiment consistent with the present invention, the layer 120 itself acts as the electrode, in which case a separate electrode layer 110 is not required. If the layer 120 lacks sufficient mechanical strength, it may be incorporated on or with another material (e.g., nylon).

Alternative conductive immobilization layers 120 are possible. For example, polyaniline (PANI) is a conducting polymer. The present inventors believe that other conductive polymers may be used for the conductive immobilization layer 120. Examples of common classes of organic conductive polymers include poly(acetylene)s, poly(pyrrole)s, poly(thiophene)s, poly(aniline)s, poly(p-phenyliene sulfide), poly(para-phenylene vinylene)s, polyacetylene (PA), Polypyrrole (PPy), and Polythiophene (PT).

Alternative probes 130 include, for example, other ODNs (preferably between 6 and 75 nucleotides), polymerase chain reaction (“PCR”) products, genomic DNAs, bacterial artificial chromosomes (“BACs”), plasmids, etc.

§ 4.3 Exemplary Techniques for Fabricating Sensors

A sensor consistent with the present invention, such as the one illustrated in FIG. 1 for example, may be fabricated by providing the conductive immobilization layer 120 (e.g., PANI) onto the electrode 110. The probes 130 may then be immobilized onto the layer 120. This immobilization may be performed, for example, by cyclic voltammetry (CV).

One exemplary embodiment consistent with the present invention uses thiol immobilization during sensor fabrication. Functional thiols can reduce emeraldine state to leucoemeraldine state simultaneously derivatizing the backbones to form functionalized polyanilines. (See, e.g., Han, C. C., Hseih, W.-D., Yeh, J.-Y., Hong, S.-P., “Combination of Electrochemistry with Concurrent Reductions and Substitution Chemistry to Provide a Facile and Versatile Tool for Preparing Highly Functionalized Polyanilines”, Chem. Mater. 1999, 11, 480-486; and Han, C. C., Hong, S.-P., Yang, K.-F., Bai, M.-Y., Lu, C.-H., Huang, C.-S., “Highly Conducting New Aniline Copolymers Containing Butylthio Substituent”, Macromolecules, 2001, 34, 587-591.) Thiol linkage formation via sulfide bonds (neither disulfide nor thiol) at the diiminoquinoid rings was confirmed with X-ray photoelectron spectroscopy and with attenuated total reflectance infrared spectroscopy (“ATRIR”). The substitution only happened when diiminoquinoid structures were present. The reduced polyaniline backbone can be reoxidized to restore the emeraldine state (but not to pernigraniline state). Concurrent reduction and substitution with regard to electro-donating thiol groups is discussed, for example, in Han, C. C., Jeng, R.-C., “Concurrent reduction and modification of polyaniline emeraldine base with pyrrolidine and other nucleophiles,” Chem. Commun., 1997, 553-554; Bergman, B., Hanks, T. W., “Spectroscopic, Microscopic, and Surface Analysis of Alkanethiol- and FluoroAlkanethiol-Modified Conducting Polymer Thin Films”, Macromolecules, 2000, 33, 80-35-8042; and Mazur, M., Krysinski, P., “Covalently Immobilized 1,4-Phenyldiamine on 11-Mercaptoundecanoic Acid-Coated Gold: Effect of Surface-Confined Monomers on the Chemical in Situ Deposition of Polyaniline and Its Derivatives,” Langmuir, 2001,, 17, 7093-7101.

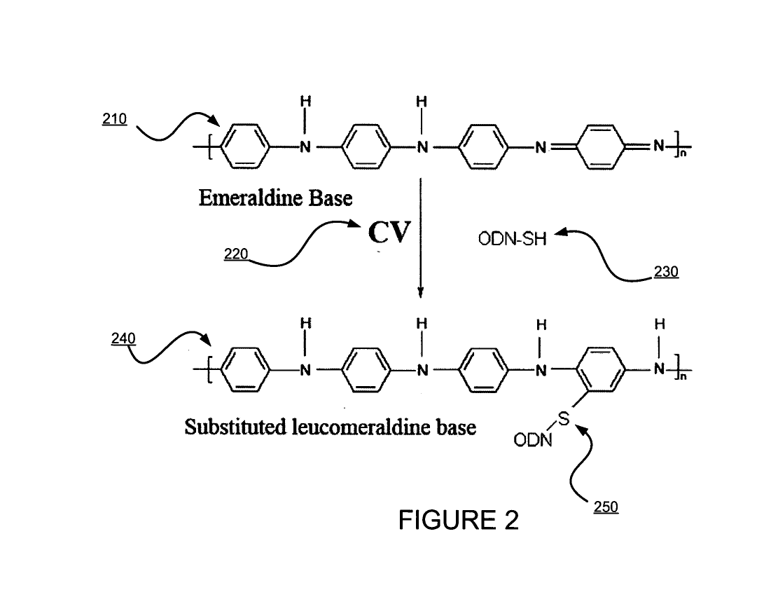

FIG. 2 illustrates immobilization of ODN probes 230 onto polyaniline 210 by application of CV 220 in the presence of sulfhydryl group SH (e.g., thiol) 230. Product 240 results. Note S 250.

§ 4.4 Exemplary Systems

As is known in the art, cyclic voltammetry (“CV”) allows the electroactivity of compounds to be studied. This may involve the transfer of electrodes from one substance (e.g., a target) to another (e.g., the probes 130). Basically, cyclic voltammograms trace the transfer of electrons during a reaction, typically a redox reaction. The reaction begins at a certain potential. As the potential changes, it controls the point at which the redox reaction will occur. The potential is increased linearly, and then the direction of the potential is reversed at the end of the first scan. Thus, the waveform in CV is usually of the form of an isosceles triangle. A repeated triangular waveform is commonly referred to as a “sawtooth” waveform. This allows the product of the electron transfer reaction that occurred in the forward scan to be probed again in the reverse scan. CV is useful to determine formal redox potentials, to detect chemical reactions that precede or follow the electrochemical reaction, and to evaluate electron transfer kinetics.

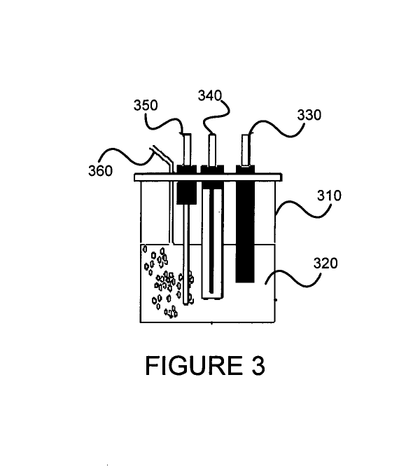

As shown in FIG. 3, an electrochemical cell includes a (e.g., glass) cell 310 including electrolyte solution 320. (Electrolyte is usually added to the compound solution to ensure sufficient conductivity. The combination of the solvent and the electrolyte determines the range of the potential.) Three electrodes are provided. First, a working electrode 330 is provided, which detects the manifestation of the electrochemical phenomena being investigated. Second, a reference electrode 340 has a potential which is constant enough so that it can be used as the reference standard against which the potentials of the other electrodes present in the cell can be measured. Third, a counter or auxiliary electrode 350 serves as a source or sink for electrons so that current can be passed from the external circuit through the cell. Tube(s) 360 permit nitrogen or helium to be introduced into the cell 310 to purge out oxygen (contained in air).

The working electrode 330 may be ITO glass, platinum or glassy carbon. Alternatively, the working electrode 330 may be gold, silver, palladium, rhodium, iridium, or some other suitable material. As stated above, the working electrode 330 can be the conducting polymer itself. Accordingly, in at least some embodiments consistent with the present invention, the working electrode 330 can be polyaniline. The reference electrode 340 may be Ag/AgCl. Alternatively, the reference electrode 340 may be some other suitable material such as KCl saturated calomel half cell (SCE). The auxiliary electrode 350 may be platinum wire for example.

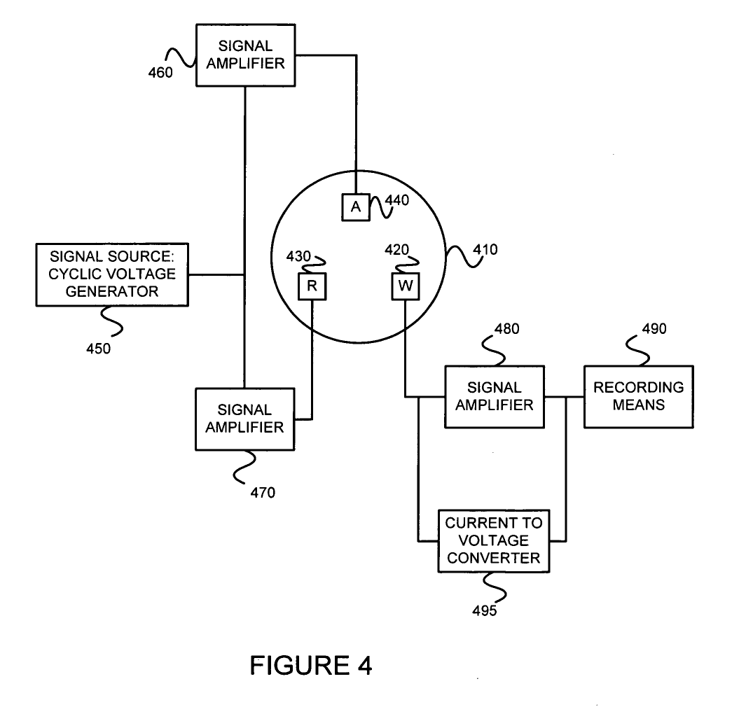

A sensor, such as that illustrated in FIG. 1, can be used with CV to detect the presence of material complementary to the immobilized probes 130. FIG. 4 illustrates a system 400 consistent with the present invention. The system includes signal source 450, signal amplifiers 460, 470, 480, cell 410, current-to-voltage converter 495 and recording means 490. The cell 410 includes working electrode 420 (such as that illustrated in FIG. 1), reference electrode 430 and auxiliary electrode 440. Signal amplifier 470 may be a potentiostatic control circuit and maintain the voltage of the reference electrode 430. An output signal from signal source 450 may be amplified by signal amplifier 460 and applied to auxiliary electrode 440. A current induced in working electrode 420 can be amplified by signal amplifier 480 and current to voltage converter 495 may measure the resulting current. Collected current readings can be saved on recording means 490.

§ 4.5 Exemplary Methods of Using Such Systems

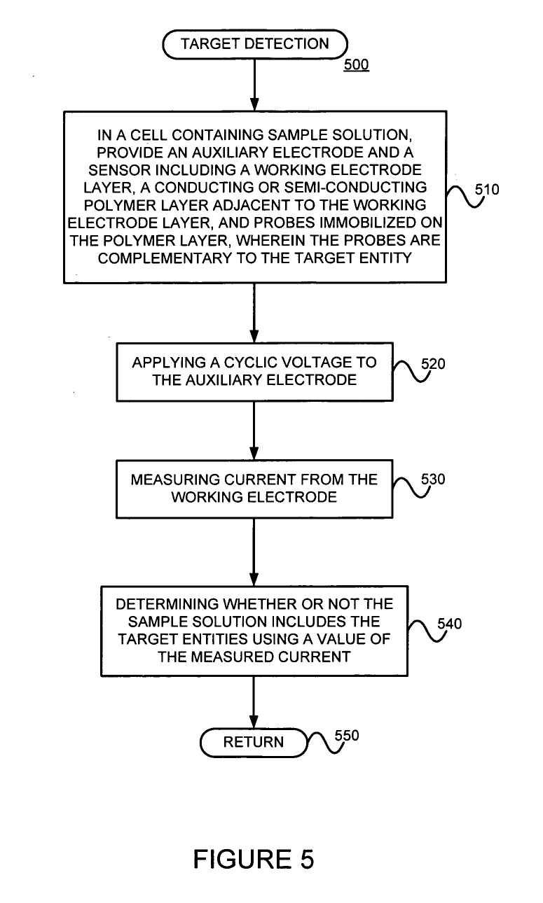

FIG. 5 is a flow diagram of an exemplary method 500 for detecting a target in solution, in a manner consistent with the present invention. In a cell including the sample solution, a sensor including a working electrode layer, a conducting or semi-conducting polymer layer adjacent to the working electrode layer, and probes immobilized on the polymer layer (wherein the probes are complementary to the target entities) is provided, and an auxiliary electrode is also provided. (Block 510) A cyclic voltage is applied to the auxiliary electrode. (Block 520) The cyclic voltage may have a sawtooth waveform. A current from the working electrode is measured. (Block 530). Finally it is determining whether or not the sample solution includes the target entities using a value of the current. (Block 540)

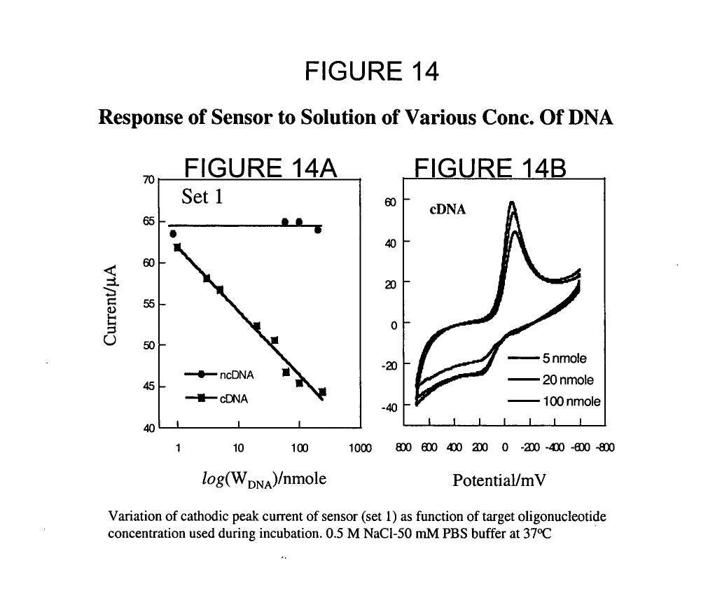

Referring back to block 540, such a determination may be made using the peak values, from which a concentration may be derived (See, e.g., FIGS. 14A, 15A, 16A and 17A.)

§ 4.6 Refinements and Alternatives

The working electrodes may be miniaturized. In this way, a plurality of working electrodes may be provided on a single chip, in much the same was the transistors are provided on a chip. Since the probes are immobilized onto the conductive immobilization layer electrochemically, different probes may be immobilized onto different working electrodes by selectively activating one or more appropriate electrodes in the presence of different probes. In this way, probes can be selectively immobilized onto one or more electrodes without being immobilized on the others. Other techniques for making sensors with different probes will be apparent to those skilled in the art in light of this disclosure.

§ 4.7 Experimental Results

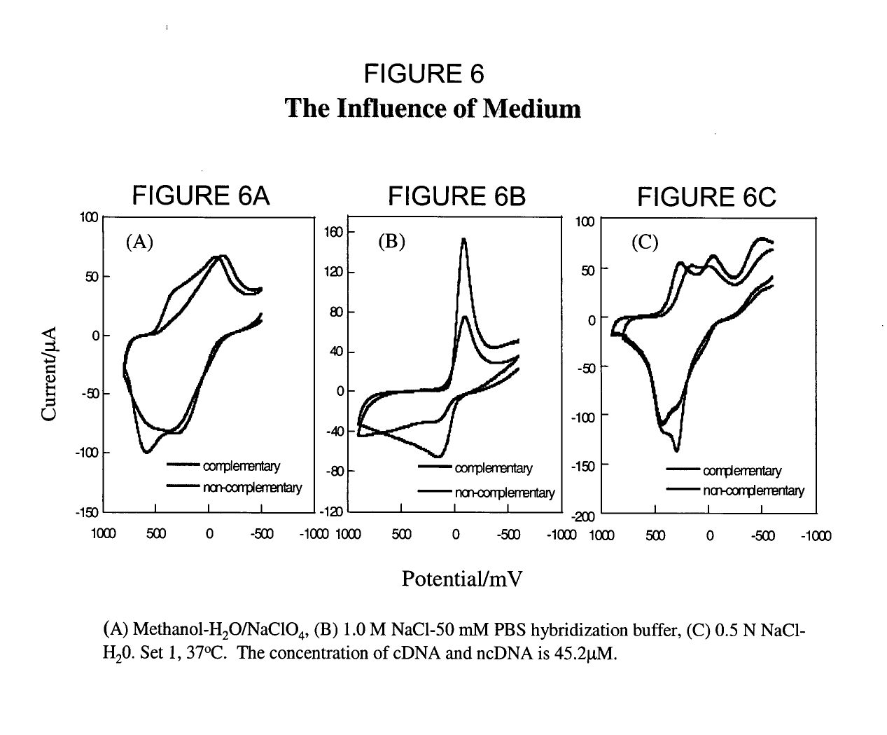

FIGS. 6A-17B illustrate results of experiments conducted using sensors fabricated and used in manners consistent with the present invention.

The probe and targets used were as follows. Oligonucleotides from Genemed Synthesis, Inc. where used.

Set 1:
Probe 1:
5′-CCT/AAG/AGG/GAG/`/TG-3′
Complementary:
5′-CAC/TCC/CTC/TTA/GG-3′
Set 2:
Probe:
5′-TCA/ATC/TCG/GGA/ATC/TCA/ATG/TTA/G-3
Complementary:
5′-CTA/ACA/TTG/AGA/TTC/CCG/AGA/TTG/A-3′
One-base mismatch:
5′-CTA/ACA/TTG/AGA/TTC/ACG/AGA/TTG/A-3′
Non-complementary:
5′-GGT/GAT/AGA/AGT/ATC-3′
Set 3:
Probe 3 (2-1):
5′-TGT/GAC/AAC/CAC/ATC/ACT/GT-3′
cDNA:
5′ACA/GTG/ATG/TGG/TTG/TCA/CA-3′
Probe 4 (1-1):
5′-TGT/GAC/AAC/CAC/ATC/ACT/GA-3′
cDNA:
5′-TCA/GTG/ATG/TGG/TTG/TCA/CA-3′
50% mismatch:
5′-AGT/CTG/ATG/AGG/TAC/TGT/GA-3′
100% mismatch:
5′-GCA/ACG/ACC/CTT/GAC/ACA/CG-3′

For each sample, 1 and 5 μg of the sample was run on a 0.8% Agarose gel in 1×TAE (Tris/Acetate/EDTA) buffer and visualized after staining with Ethidium Bromide under short-wave UV illumination to determine average size of the products.

Experimental ODN sensors were fabricated as follows. ODN probes were attached on a PANi film by cyclic voltammetry (EG&G/VeraStat II) with the three-electrode system consisted of a Ag/AgCl reference electrode, platinum wire as an auxiliary electrode and a Pt, glassy carbon electrode or ITO glass as a working electrode.

Hybridization assays were prepared as follows. ODN strands were dissolved in a stock PBS hybridization buffer (0.5 M NaCl, 50 mM PO4-n, pH 7.0). Assays were done using solution temperatures of 37° C.

FIGS. 6A-17B illustrate results of experiments conducted using sensors fabricated and used in manners consistent with the present invention.

FIGS. 6A-6C illustrate cyclic voltammograms illustrating the influence of buffer fluid on CV test measurements of an experimental sensor consistent with the present invention.

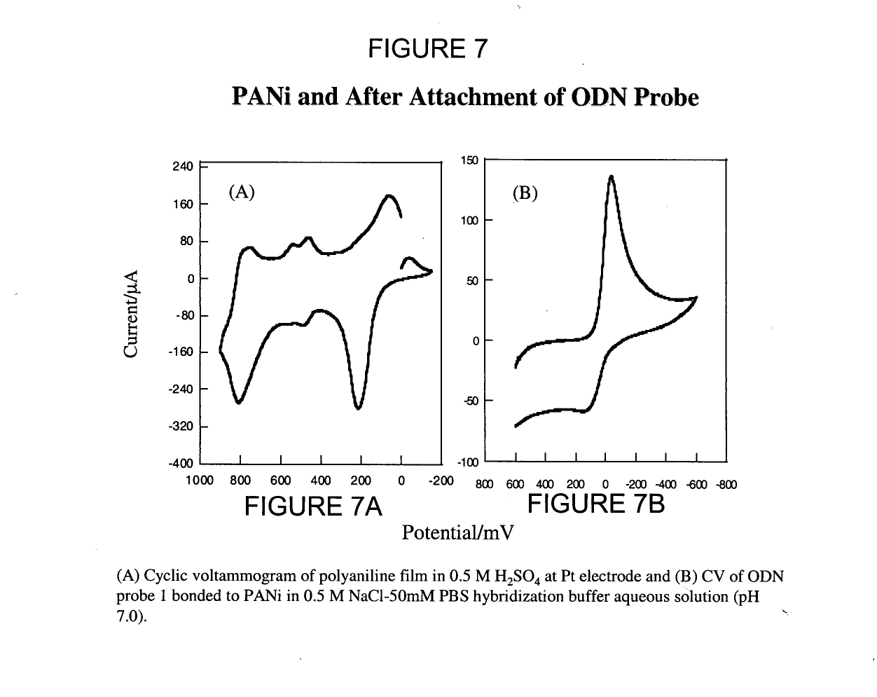

FIGS. 7A and 7B illustrate cyclic voltammograms of a (partial) sensor with polyaniline film and a sensor with ODN immobilized on polyaniline film. Notice that in FIG. 7A, two peaks at about 200 and 800 mV correspond to oxidation and reduction. In contrast, notice that in FIG. 7B, a single peak occurs at about 75 mV.

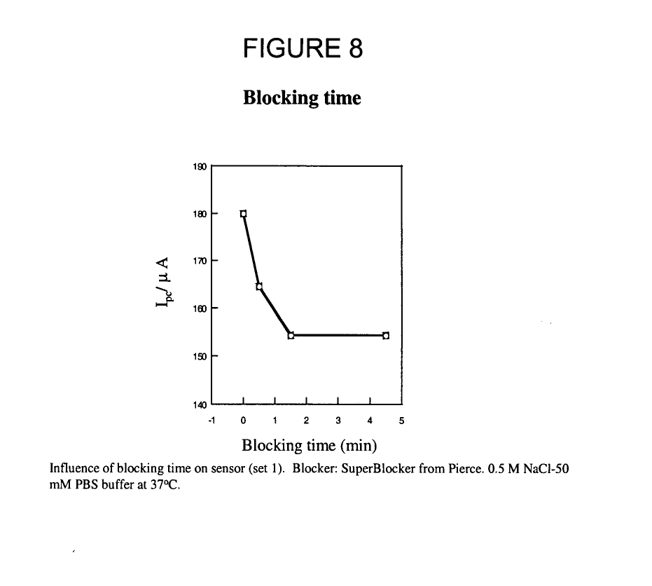

FIG. 8 illustrates the influence of blocking time on peak current using experimental sensors consistent with the present invention.

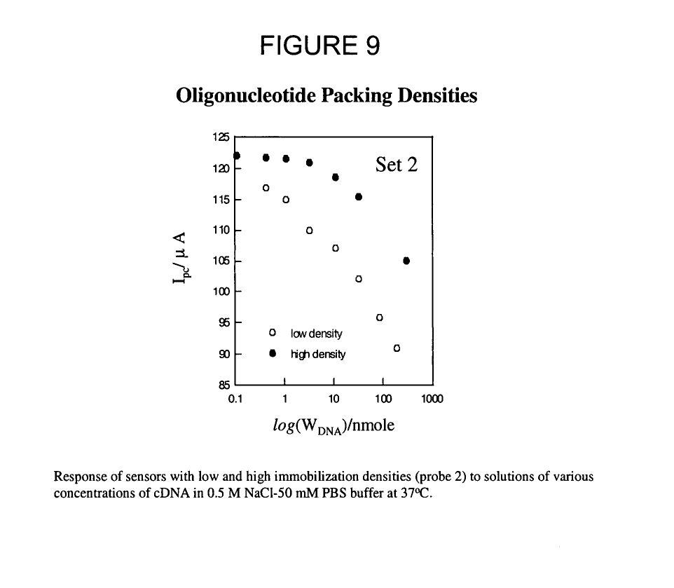

FIG. 9 illustrates the influence of ODN density on peak current using experimental sensors consistent with the present invention.

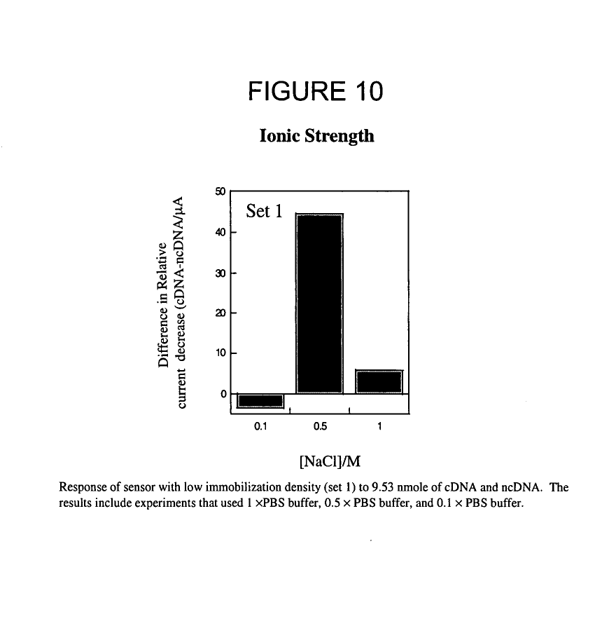

FIG. 10 illustrates the influence of buffer on current differences when an experimental sensor, consistent with the present invention, is exposed to complementary DNA and non-complementary DNA.

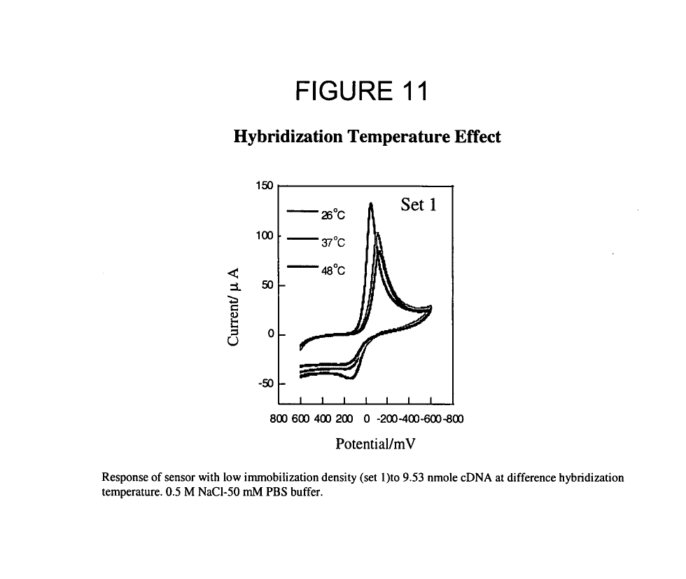

FIG. 11 illustrates the influence of hybridization temperature on cyclic voltammograms using an experimental sensor consistent with the present invention.

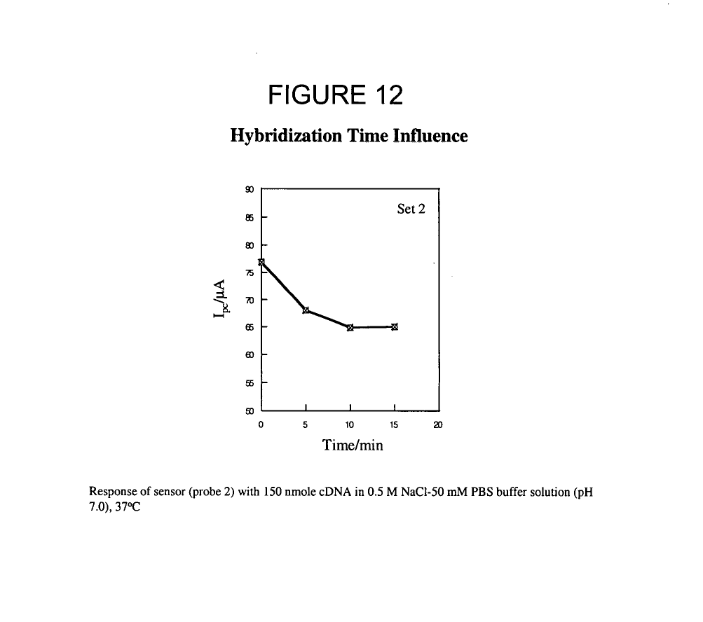

FIG. 12 illustrates the influence of hybridization time on peak current using experimental sensors consistent with the present invention.

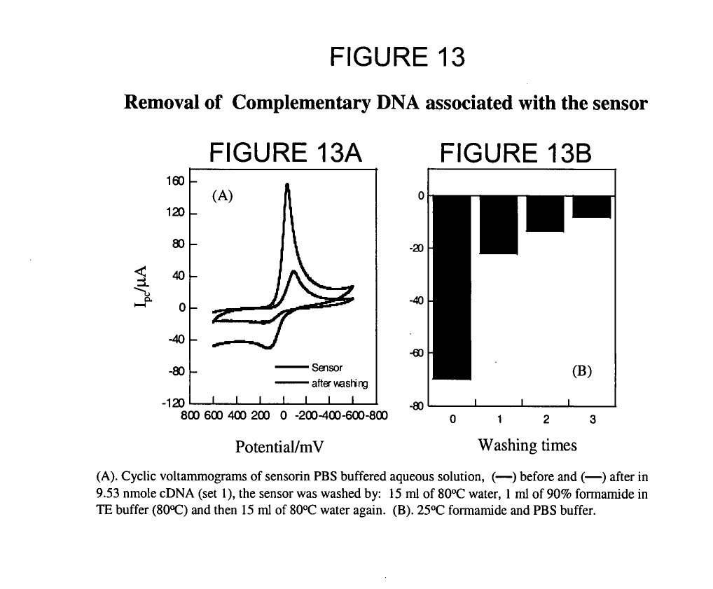

FIGS. 13A and 13B illustrate the influence of washing and washing times on peak current using an experimental sensor consistent with the present invention.

FIGS. 14A and 14B illustrate the influence of target concentration during incubation on peak current using experimental sensors consistent with the present invention.

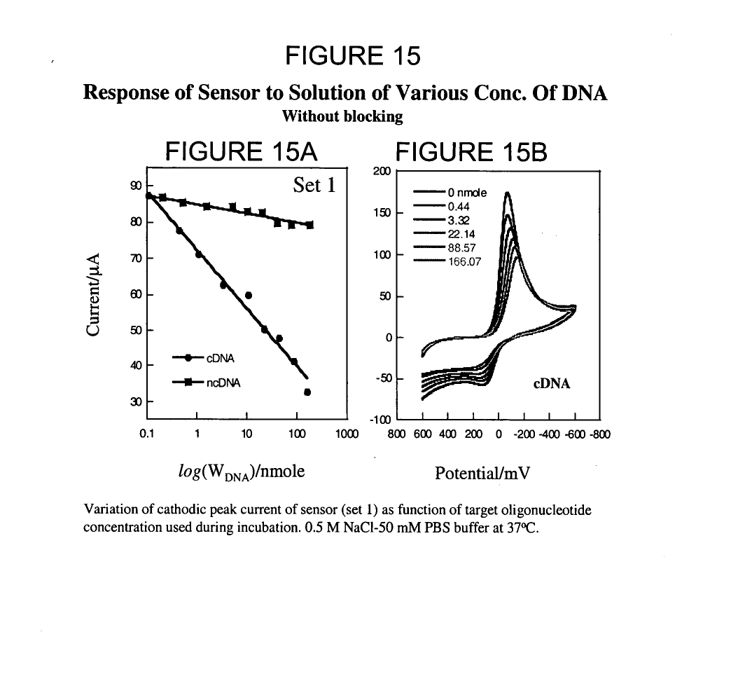

FIGS. 15A and 15B illustrate the influence of target concentration during incubation peak current using an experimental sensor consistent with the present invention.

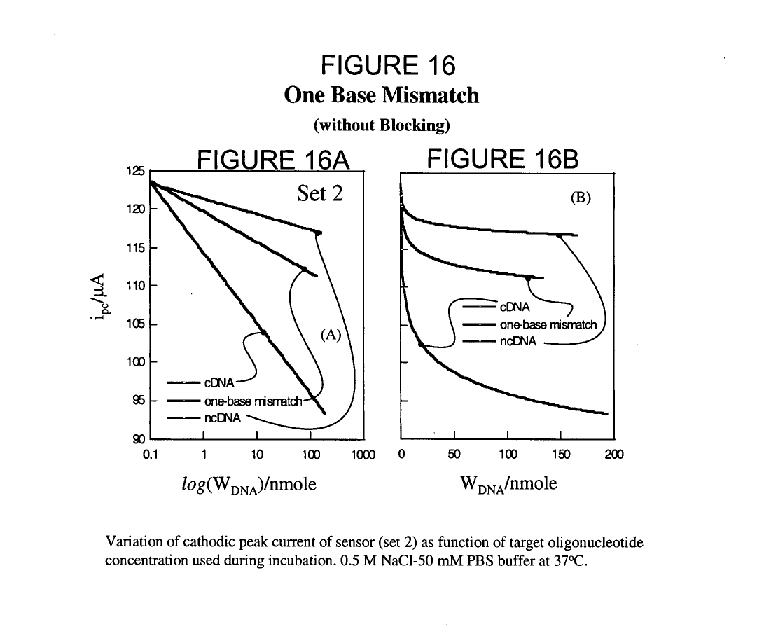

FIGS. 16A and 16B illustrate the influence of target concentration during incubation on peak current using an experimental sensor consistent with the present invention.

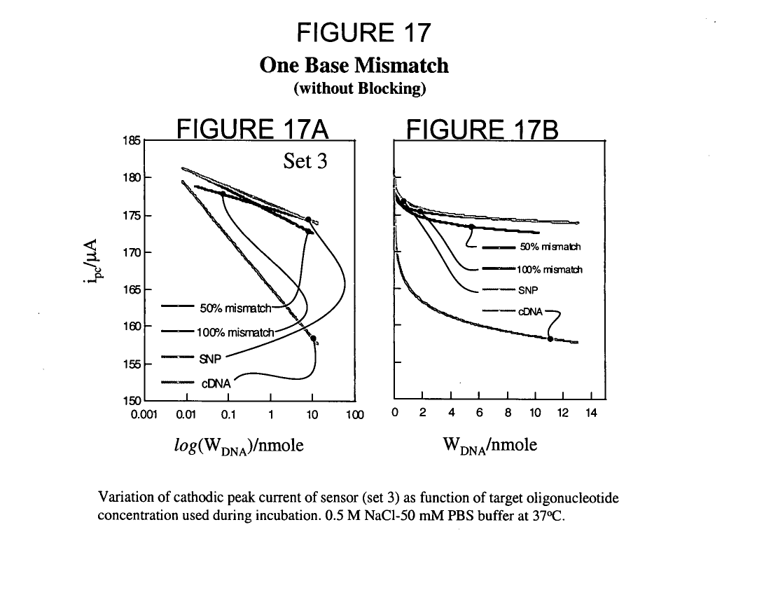

FIGS. 17A and 17B illustrate the influence of target concentration during incubation on peak current using an experimental sensor consistent with the present invention.

### § 5. CONCLUSIONS

Sensors consistent with the present invention can specifically recognize hybridization reactions and produce signals indicative of such reactions. Such sensors advantageously avoid the need for additional indicators or labels, such a fluorescent labels normally found on DNA microarrays, as well as the associated readout and analysis equipment which can be expensive. Such sensors may advantageously provide a relatively fast hybridization reaction time. Such sensors can advantageously exhibit high selectivity for complementary and mismatched target nucleotide sequences, even when such sequences have only a single nucleotide mismatch. Sensors consistent with the present invention can be easily fabricated by electrochemical immobilization of probes on a conducting polymer. Finally, sensors consistent with the present invention may be used with relatively simple and inexpensive test equipment.

What is claimed is:

1. A sensor comprising:
a) a conducting or semi-conducting polymer; and
b) probes immobilized, via sulfur, on the polymer, wherein the probes are selected from a group consisting of (A) oligonucleotides, (B) polymerase chain reaction products, (C) genomic DNAs, (D) bacterial artificial chromosomes, and (E) plasmids.

2. The sensor of claim 1 wherein the polymer acts as an electrode.

3. The sensor of claim 1 further comprising:
c) an electrode layer, wherein the polymer is provided on the electrode layer.

4. The sensor of claim 3 wherein the electrode layer is selected from a group consisting of (A) ITO glass, (B) platinum, and (C) glassy carbon.

5. The sensor of claim 1 wherein the probes are oligionucleotide strands, each strand including between 6 and 75 nucleotides.

6. The sensor of claim 1 wherein the probes are oligionucleotide strands, each strand including between 15 and 24 nucleotides.

7. The sensor of claim 1 wherein the polymer layer includes a conducing polymer of the rigid rod polymer family.

8. The sensor of claim 1 wherein the polymer layer includes polyaniline.

9. The sensor of claim 1 wherein the polymer has a leucoemeraldine state backbone.

10. A method for fabricating a sensor including a conducting or semi-conducting polymer layer, and probes immobilized on the polymer layer, wherein the probes are selected from a group consisting of (A) oligionucleotides, (B) polymerase chain reaction products, (C) genomic DNAs, (D) bacterial artificial chromosomes, and (E) plasmids, the method comprising:
a) providing the polymer layer; and
b) immobilizing the probes on the polymer layer using an electro-chemical immobilization technique in the presence of nucleophiles.

11. The method of claim 10 wherein the electrochemical immobilization technique includes application of cyclic voltage to the electrode layer and a second electrode while the polymer layer is immersed in a solution including the probes.

12. The method of claim 10 wherein the nucleophiles are thiol groups.

13. The method of claim 12 wherein the thiol groups have been chemically synthesized onto the probes.

14. A method for detecting target entities in a sample solution, the method comprising:
a) providing, in a cell including the sample solution, a sensor including a conducting or semi-conducting polymer layer, and probes immobilized, via sulfur, on the polymer layer, wherein the probes are complementary to the target entities;
b) providing an auxiliary electrode in the cell including the sample solution;
c) applying a cyclic voltage to the auxiliary electrode;
d) measuring a current from the polymer layer; and
e) determining whether or not the sample solution includes the target entities using a value of the current.

15. The method of claim 14 wherein the probes are selected from a group consisting of (A) oligionucleotides, (B) polymerase chain reaction products, (C) genomic DNAs, (D) bacterial artificial chromosomes, and (E) plasmids.

16. The sensor of claim 14 wherein the probes are oligionucleotide strands, each strand including between 6 and 75 nucleotides.

17. The sensor of claim 14 wherein the probes are oligionucleotide strands, each strand including between 15 and 24 nucleotides

18. The sensor of claim 14 wherein the polymer layer is provided on a working electrode selected from a group consisting of (A) ITO glass, (B) platinum, and (C) glassy carbon.

19. The sensor of claim 14 wherein the polymer layer includes a conducing polymer of the rigid rod polymer family.

20. The sensor of claim 14 wherein the polymer layer includes polyaniline.


SEQUENCE LISTING (13 sequences)

SEQ ID NO: 1 - DNA, 14 bp, Artificial
  Synthetic Construct
cctaagagggagtg

SEQ ID NO: 2 - DNA, 14 bp, Artificial
  Synthetic Construct
cactccctcttagg

SEQ ID NO: 3 - DNA, 15 bp, Artificial
  Synthetic Construct
ggtgatagaagtatc

SEQ ID NO: 4 - DNA, 25 bp, Artificial
  Synthetic Construct
tcaatctcgggaatctcaatgttag

SEQ ID NO: 5 - DNA, 25 bp, Artificial
  Synthetic Construct
ctaacattgagattcccgagattga

SEQ ID NO: 6 - DNA, 25 bp, Artificial
  Synthetic Construct
ctaacattgagattcacgagattga

SEQ ID NO: 7 - DNA, 15 bp, Artificial
  Synthetic Construct
ggtgatagaagtatc

SEQ ID NO: 8 - DNA, 20 bp, Artificial
  Synthetic Construct
tgtgacaaccacatcactgt

SEQ ID NO: 9 - DNA, 20 bp, Artificial
  Synthetic Construct
acagtgatgtggttgtcaca

SEQ ID NO: 10 - DNA, 20 bp, Artificial
  Synthetic Construct
tgtgacaaccacatcactga

SEQ ID NO: 11 - DNA, 20 bp, Artificial
  Synthetic Construct
tcagtgatgtggttgtcaca

SEQ ID NO: 12 - DNA, 20 bp, Artificial
  Synthetic Construct
agtctgatgaggtactgtga

SEQ ID NO: 13 - DNA, 20 bp, Artificial
  Synthetic Construct
gcaacgacccttgacacacg